(19) United States
(12) Patent Application Publication
(10) Pub. No.: US 2022/0230485 A1
(43) Pub. Date: Jul. 21, 2022

(54) VEHICULAR CONTROL SYSTEM WITH FAILURE MODE ANALYSIS

(71) Applicant: Magna Electronics Inc., Auburn Hills, MI (US)

(72) Inventors: Devendra Bajpai, Bloomfield Hills, MI (US); Krishna R. Rao, Rochester Hills, MI (US)

(21) Appl. No.: 17/648,181

(22) Filed: Jan. 18, 2022

Related U.S. Application Data
(60) Provisional application No. 63/199,699, filed on Jan. 19, 2021.

(51) Int. Cl. G07C 5/08

(52) U.S. Cl. CPC G07C 5/0808

(57) ABSTRACT

A method for generating fault modes and effects analysis for a vehicular advanced driver-assistance system includes providing a vehicle equipped with an advanced driver-assistance system, determining a plurality of system components of the advanced driver-assistance system, and determining fault propagation paths between each of the system components. Internal component fault propagations of each of the system components of the plurality of system components are determined. Inter-component failure propagations along each of the determined fault propagation paths are determined. Each of (i) a severity of failure for each system component, (ii) a probability of failure occurrence for each system component, and (iii) a detectability of failure for each system component is determined. A critical item list report is generated based at least in part on the determined severity of failure, the determined probability of failure occurrence, and the determined detectability of failure.

### CROSS REFERENCE TO RELATED APPLICATION

The present application claims the filing benefits of U.S. provisional application Ser. No. 63/199,699, filed Jan. 19, 2021, which is hereby incorporated herein by reference in its entirety.

### FIELD OF THE INVENTION

The present invention relates generally to a vehicle vision system for a vehicle and, more particularly, to a vehicle vision system that utilizes one or more cameras at a vehicle.

### BACKGROUND OF THE INVENTION

Use of imaging sensors in vehicle imaging systems is common and known. Examples of such known systems are described in U.S. Pat. Nos. 5,949,331; 5,670,935 and/or 5,550,677, which are hereby incorporated herein by reference in their entireties.

### SUMMARY OF THE INVENTION

A method for generating fault modes and effects analysis for a vehicular advanced driver-assistance system includes providing a vehicle equipped with an advanced driver-assistance system, determining a plurality of system components of the advanced driver-assistance system, and determining fault propagation paths between each of the system components. The method includes determining internal component fault propagations of each of the system components of the plurality of system components. The method includes determining inter-component failure propagations along each of the determined fault propagation paths. The method also includes determining each of (i) a severity of failure for each system component, (ii) a probability of failure occurrence for each system component, and (iii) a detectability of failure for each system component is determined. The method includes generating a critical item list report based at least in part on the determined severity of failure, the determined probability of failure occurrence, and the determined detectability of failure. These and other objects, advantages, purposes and features of the present invention will become apparent upon review of the following specification in conjunction with the drawings.

### BRIEF DESCRIPTION OF THE DRAWINGS

FIG. 1 is a plan view of a vehicle with a vision system that incorporates cameras;

FIG. 2 is a block diagram of failure mode process steps;

FIG. 3 is a block diagram of the failure mode process steps of FIG. 2;

FIG. 4 is a block diagram of a software fault modes and effects analysis process;

FIG. 5 is a table of the software fault modes and effects analysis process of FIG. 4;

FIGS. 6A-6E are tables of definitions and descriptions of the software fault modes and effects analysis process of FIG. 4;

FIGS. 7A-8B are schematic views of exemplary architectures of the software fault modes and effects analysis process of FIG. 4;

FIG. 9 is a schematic view of an exemplary component level of the software fault modes and effects analysis process of FIG. 4;

FIGS. 10A-10C are tables of severities, probability of occurrences, and detectability of the software fault modes and effects analysis process of FIG. 4;

FIG. 11 is a block diagram of analysis and mitigation of a software fault modes and effects analysis process;

FIG. 12 is a table of software fault modes and effects analysis based architectural decisions; and

FIG. 13 is a block diagram of software fault modes and effects analysis process interface.

### DESCRIPTION OF THE PREFERRED EMBODIMENTS

A vehicle vision system and/or driver or driving assist system and/or object detection system and/or alert system operates to capture images exterior of the vehicle and may process the captured image data to display images and to detect objects at or near the vehicle and in the predicted path of the vehicle, such as to assist a driver of the vehicle in maneuvering the vehicle in a rearward direction. The vision system includes an image processor or image processing system that is operable to receive image data from one or more cameras and provide an output to a display device for displaying images representative of the captured image data. Optionally, the vision system may provide display, such as a rearview display or a top down or bird's eye or surround view display or the like.

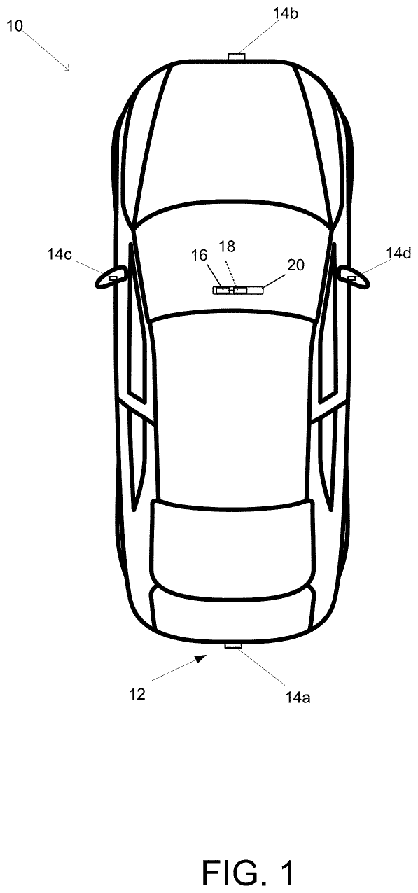

Referring now to the drawings and the illustrative embodiments depicted therein, a vehicle 10 includes an imaging system or vision system 12 that includes at least one exterior viewing imaging sensor or camera, such as a rearward viewing imaging sensor or camera 14a (and the system may optionally include multiple exterior viewing imaging sensors or cameras, such as a forward viewing camera 14b at the front (or at the windshield) of the vehicle, and a sideward/rearward viewing camera 14c, 14d at respective sides of the vehicle), which captures images exterior of the vehicle, with the camera having a lens for focusing images at or onto an imaging array or imaging plane or imager of the camera (FIG. 1). Optionally, a forward viewing camera may be disposed at the windshield of the vehicle and view through the windshield and forward of the vehicle, such as for a machine vision system (such as for traffic sign recognition, headlamp control, pedestrian detection, collision avoidance, lane marker detection and/or the like). The vision system 12 includes a control or electronic control unit (ECU) 18 having electronic circuitry and associated software, with the electronic circuitry including a data processor or image processor that is operable to process image data captured by the camera or cameras, whereby the ECU may detect or determine presence of objects or the like and/or the system provide displayed images at a display device 16 for viewing by the driver of the vehicle (although shown in FIG. 1 as being part of or incorporated in or at an interior rearview mirror assembly 20 of the vehicle, the control and/or the display device may be disposed elsewhere at or in the vehicle). The data transfer or signal communication from the camera to the ECU may comprise any suitable data or communication link, such as a vehicle network bus or the like of the equipped vehicle.

Software has become a substantial portion of many modern automobiles. For instance, the percentage of software components in some automobiles has risen from less than 10 percent to currently more than 70 percent and a typical automobile may include close to 1.5 million lines of code or more. Moreover, mobility, autonomy, digitization, and electrification are re-shaping the automobile industry and will continue to increase the role of software. Software defects and failures are increasingly caused by the increased size and complexity of the software components. Most, if not all, software failures are attributed to software requirements and design. However, these failures may not be detected by testing and validation alone.

Implementations herein describe software fault modes and effects analysis (SFMEA) as an inductive, bottom-up safety analysis method that allows the identification of failure modes (FM) of software components and the determination of their respective effects at the software functional and system levels. The analysis aims at removing potential risks from the component design of the system. For example, a methodology to analyze and discover includes (a) all potential failure modes of a system, (b) the effects these failures have on the system, and (c) how to correct and/or mitigate the failures or effects on the system.

The failure mode and effects analysis is the most widely used analysis procedure in practice at the initial stages of system development. The SFMEA is usually performed during the conceptual and initial design phases of the system in order to assure that all possible failure modes have been considered and that proper provisions have been made to eliminate all the potential failures.

Enterprise Architect (EA) is a rich and vibrant modeling environment built primarily on the Unified Modeling Language (UML) specifications. Enterprise Architect uses a wide range of tools to help manage, derive, visualize and explore complex systems covering multiple domains. The diverse environment of EA covers all aspects of system architecture and enterprise architecture through its fundamental utilities based on open source modeling specification like UML, SysML etc. Enterprise Architect includes many benefits and usages cases such as a) design and build diverse systems using UML and UML extensions such as SysML, b) model and manage complexity, c) model decomposition, d) structure use case scenarios, e) model exchange, f) model, manage and trace requirements, g) develop views and extracts of the model, h) publish documentation, and i) use model driven architecture and transformations.

The ECU software of a vehicle is often functionally decomposed into modules in EA. Implementations herein generally discuss SFMEA activity regarding software building blocks, software runtime, and software deployment views. Typically, software use cases and SFMEA are viewed separately. Use cases describe functional behavioral requirements as nominal, alternate, exception/error course of action. The SFMEA describes failure modes of software resources and mitigation of those failures.

In general the scope of SFMEA is broader than functional requirements as design choices may affect operations and non-functional behavior. Combining software use cases and SFMEA has several advantages.

The EA software architecture is a single source of all software requirements, architecture, design, detailed design and implementation. Each software component is traceable to the component directly placed above or below it (i.e., higher or lower in the hierarchy). The integration provides problem context and clearly shows the failure modes and the mitigation approaches. The integration also provides a functional framework in which classes of failure modes can be addressed (e.g. failures of pre-conditions/post-conditions are failure mode detections). The correction and mitigation is generally based on a ranking of the severity and probability of the failure.

As used herein, software failures are defined as service provision failures (e.g., omission and commission), service timing failures (e.g., early, late, never), service value failures (e.g., coarse, implausible value, subtle plausible value, etc.). As used herein, failure mode is defined as the means by which the software could contribute to a system failure. Failure effect is defined as a behavior that results from failure. Critical items list (CIL) is defined as a technique used to assign criticality ranking to each failure mode based on the severity/consequence and likelihood a failure could occur from a safety and reliability perspective.

Occurrence is defined as a rating scale that shows the probability or frequency of a particular failure. Failure effect severity is defined as the consequences of a failure as a result of a particular failure mode. Severity considers the worst potential consequence of a failure, determined by the degree of injury, property damage, or system damage, etc., that could ultimately occur. Failure detection is defined as a likelihood of detection of the failure by design control methods. The design failure to detect the failure of the component leads to a higher detection failure rating. Risk priority number (RPN) is defined as a value calculated as the product of the severity, occurrence, and detection. A hazard is defined as a situation that may pose a threat to life, health, property, or the environment.

Implementations herein describe a methodology using Enterprise Architect (EA) to improve the detectability of failures. The software elements are described as architecture components which include design, detailed design, and implementation. The implementation includes using model based techniques or traditional hand-coded software elements. The various steps include analysis, understanding system requirements and function, defining failure/success criteria, decomposing the system into elements, determining each elements failure modes and their failure effects and record these, summarizing each failure effect, and reporting findings.

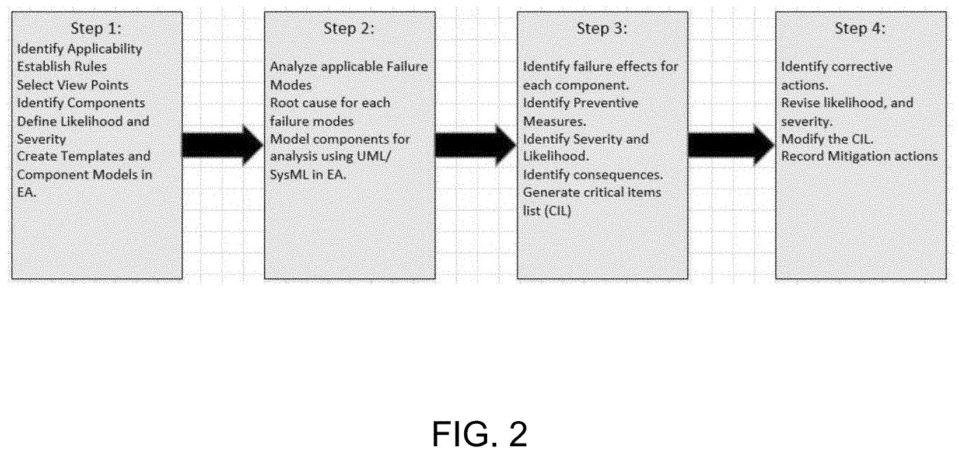

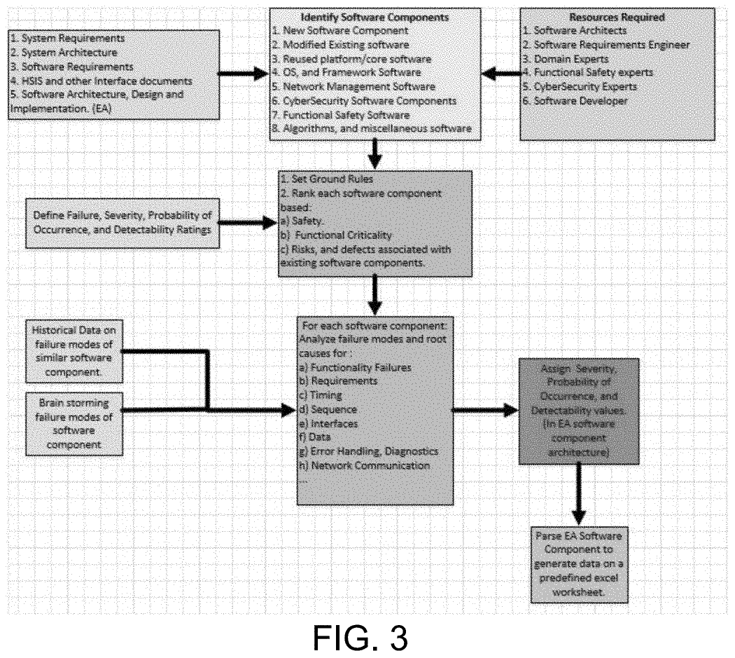

Referring now to FIGS. 2 and 3, the SFMEA generation process defines the system components to be included in the analysis using a SysML (Systems Modeling Language) Block Definition diagram. The Systems Modeling Language is a general-purpose modeling language for systems engineering applications. It supports the specification, analysis, design, verification, and validation of a broad range of systems and systems-of-systems. Some implementations include creating a SysML Internal Block diagram that identities the propagation paths among components and defining the internal component propagations using block definition diagrams and transformations using internal block definition diagrams. Optionally, SFMEA generation includes defining the inter-component failure propagations along each of the paths using SysML association blocks and failure transformations using internal block diagrams and SFMEA generation from SysML Diagrams in EA. The generation process may include computing a severity and determining a probability of occurrence and detectability for each component. The generation process may also include parsing the EA model to tabulate the failure data in a given format. FIGS. 2 and 3 define optional and various failure mode process steps.

Thus, implementations herein provide a methodology using EA. A common architecture is used to describe the functional design of the software, and the same diagram is used to analyze the various failure modes for the software components. The implementations herein also identify serious problems before the software component impacts the safety of the ECU, identify multiple instances of one failure mode, and identify software failures that cannot be detected by software testing. Optionally, implementations herein identify missing, incomplete, and ambiguous requirements/design. Optionally, implementations herein include developing mitigation strategies to reduce the severity and the RPN of the software components. Implementations herein also improve the detectability of software failures.

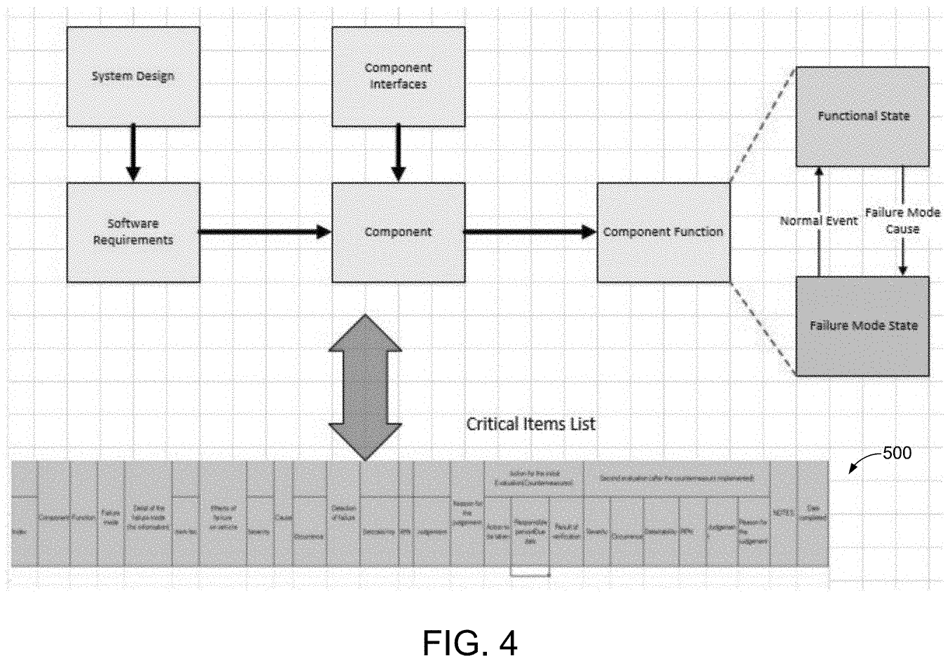

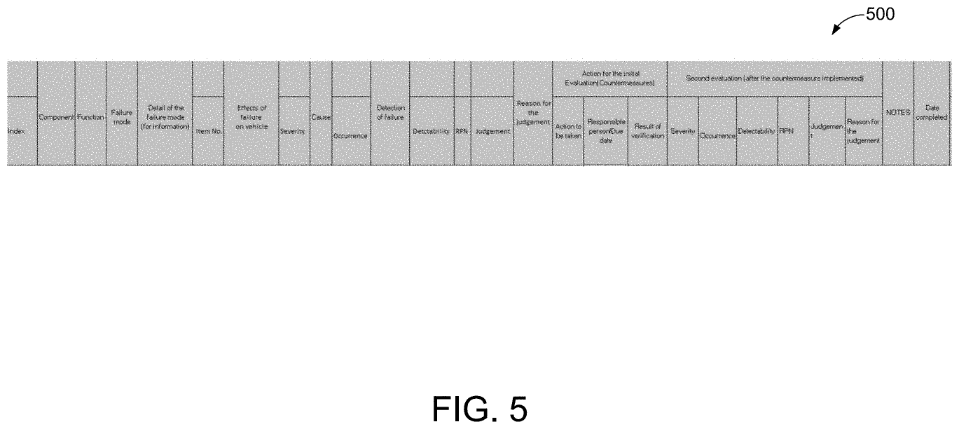

Referring now to FIG. 4, the SFMEA generation process may include defining the system components to be included in the analysis using a SysML Block Definition diagram and creating a SysML Internal Block diagram that identifies the propagation paths among the components. The generation may also include defining the internal component propagations using block definition diagrams and transformations using internal block definition diagrams and defining the inter-component failure propagations along each of the paths using SysML association blocks and failure transformations using internal block diagrams. FIG. 4 describes the SFMEA process performed for an advanced driver-assistance system (ADAS) surround view system ECU (e.g., as used by the vehicle 10 of FIG. 1). A table 500 of FIG. 4 is reproduced at FIG. 5.

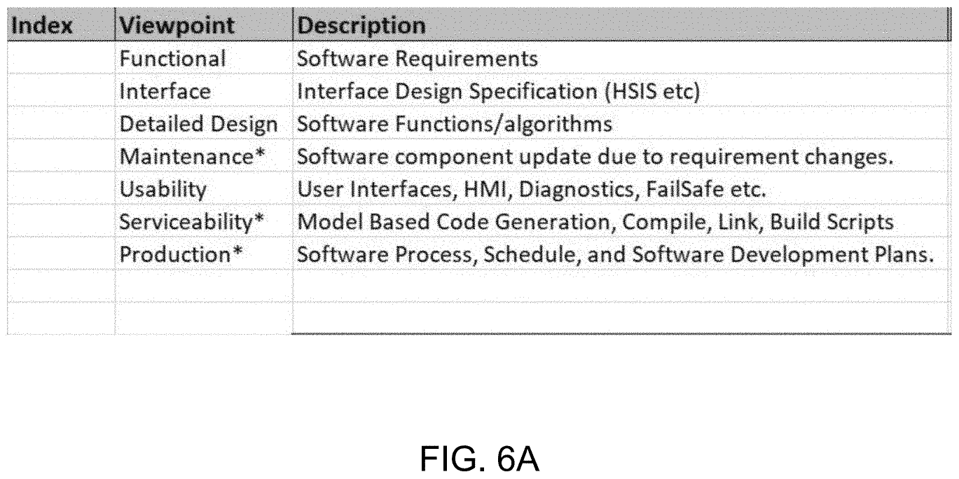

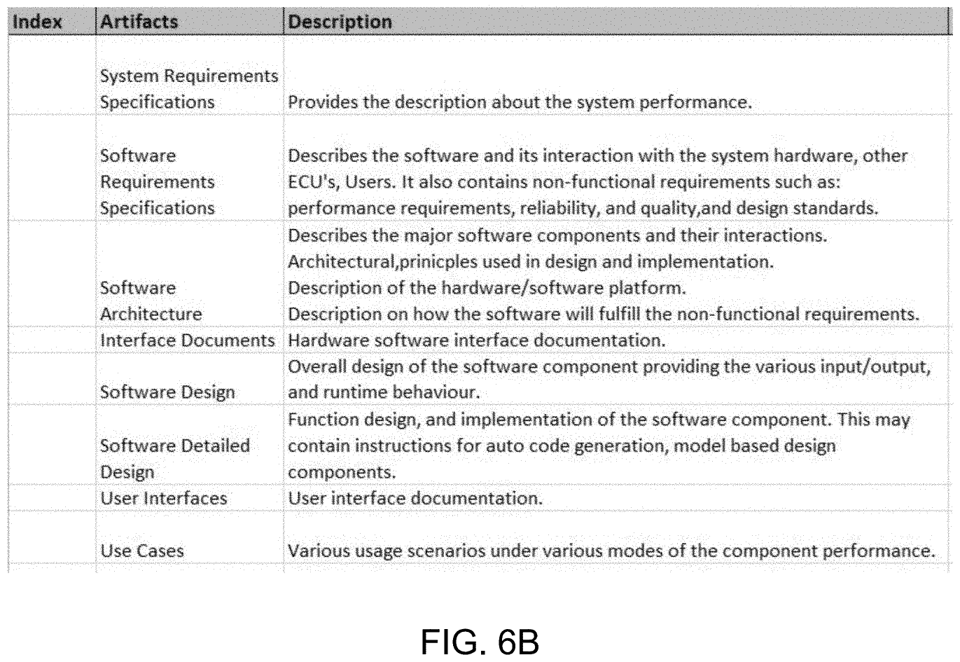

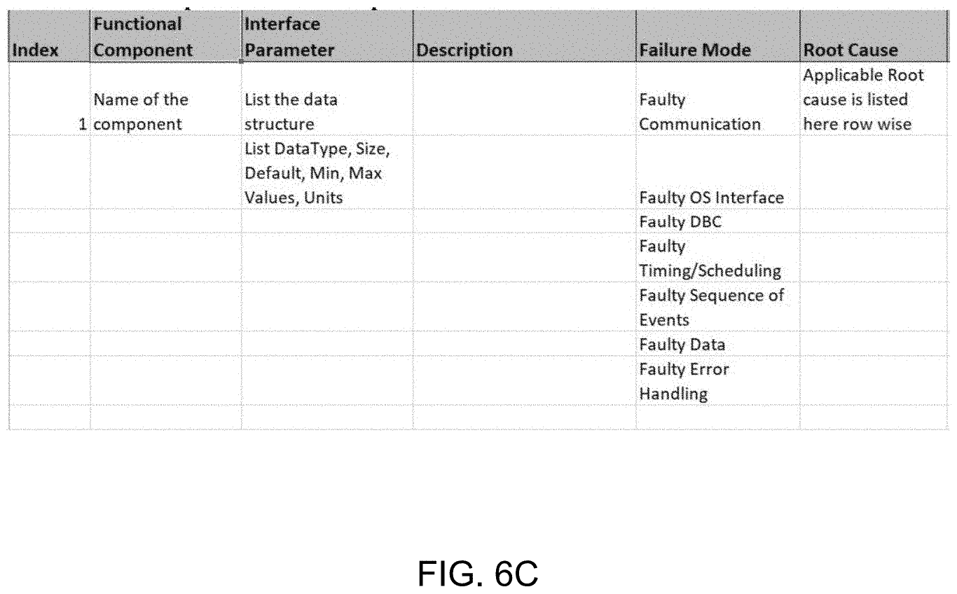

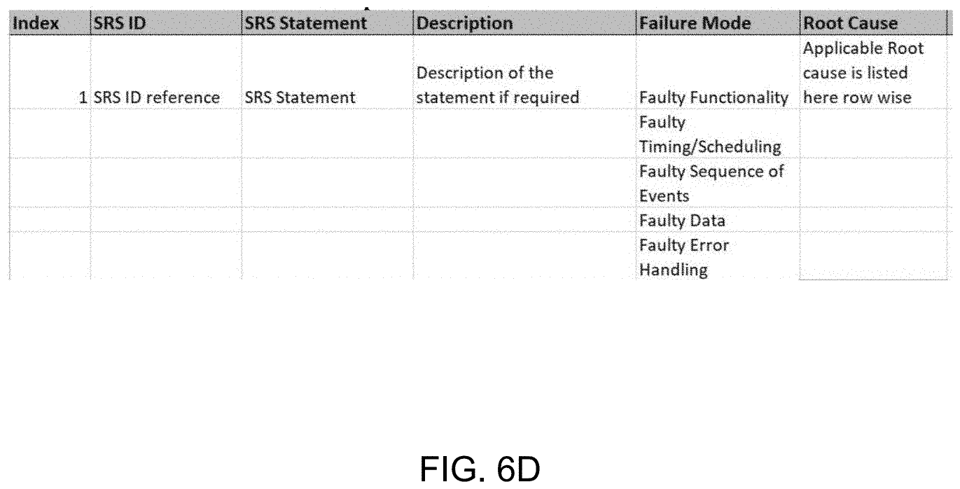

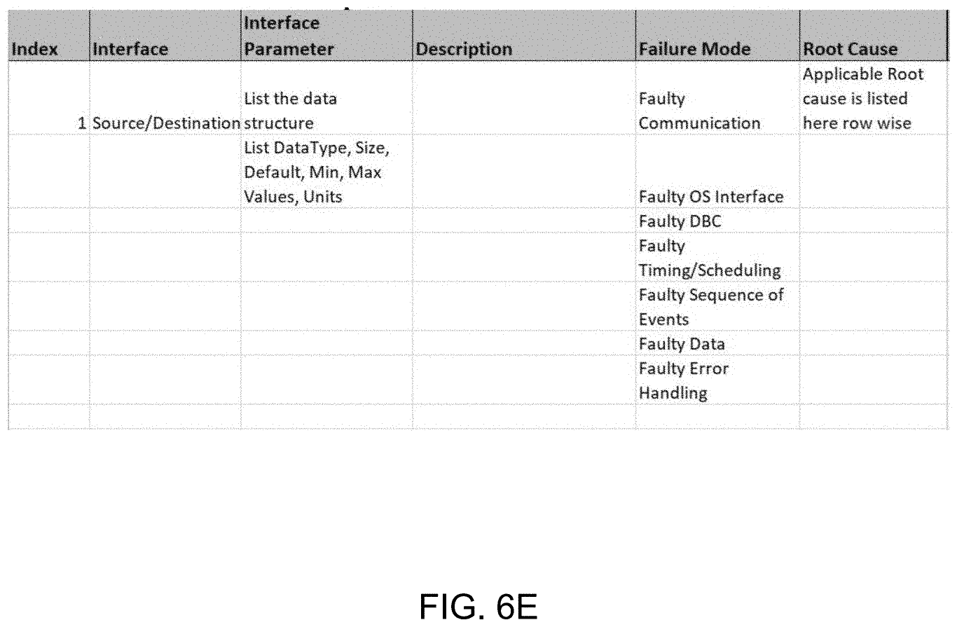

FIGS. 6A-6E include tables that further define how the SFMEA process is performed for an ADAS surround view system ECU. FIG. 6A includes SFMEA viewpoint descriptions, FIG. 6 includes SFMEA artifacts description, and FIG. 6C includes SFMEA component level template definitions. FIG. 6D includes SFMEA functional level template descriptions and FIG. 6E includes SFMEA interface level template descriptions.

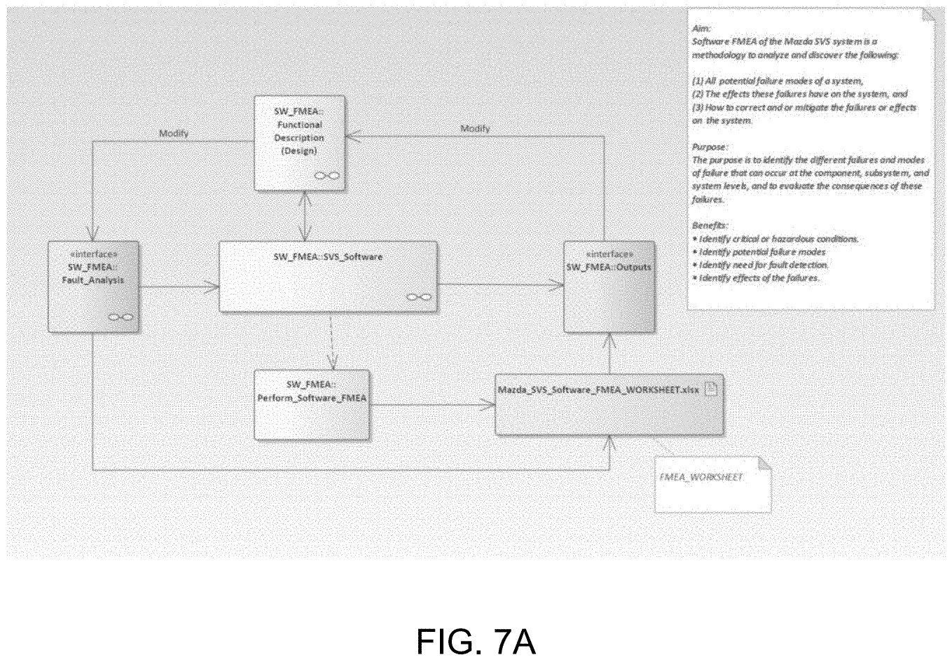

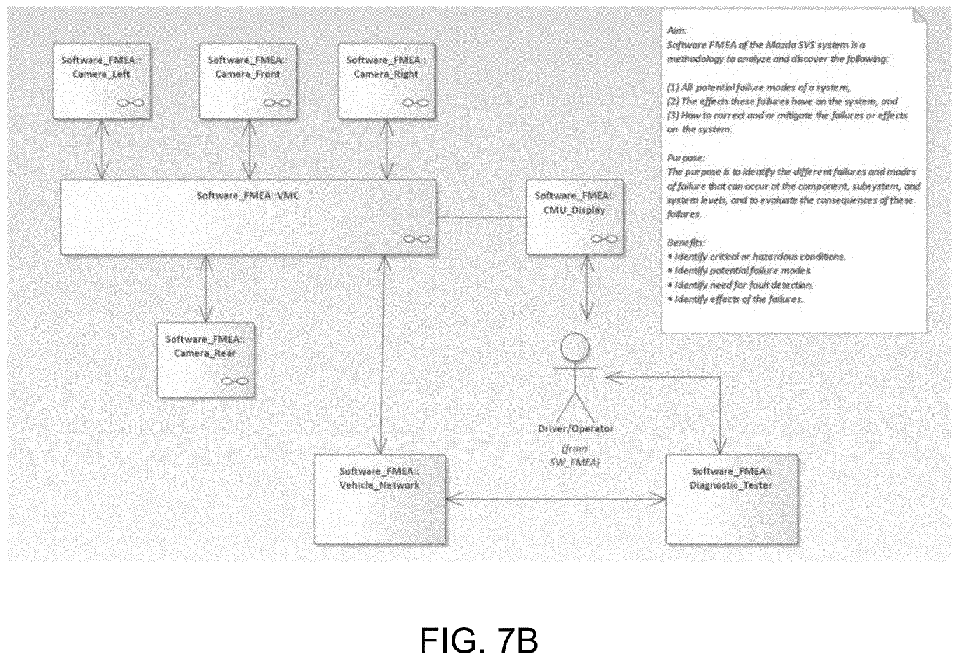

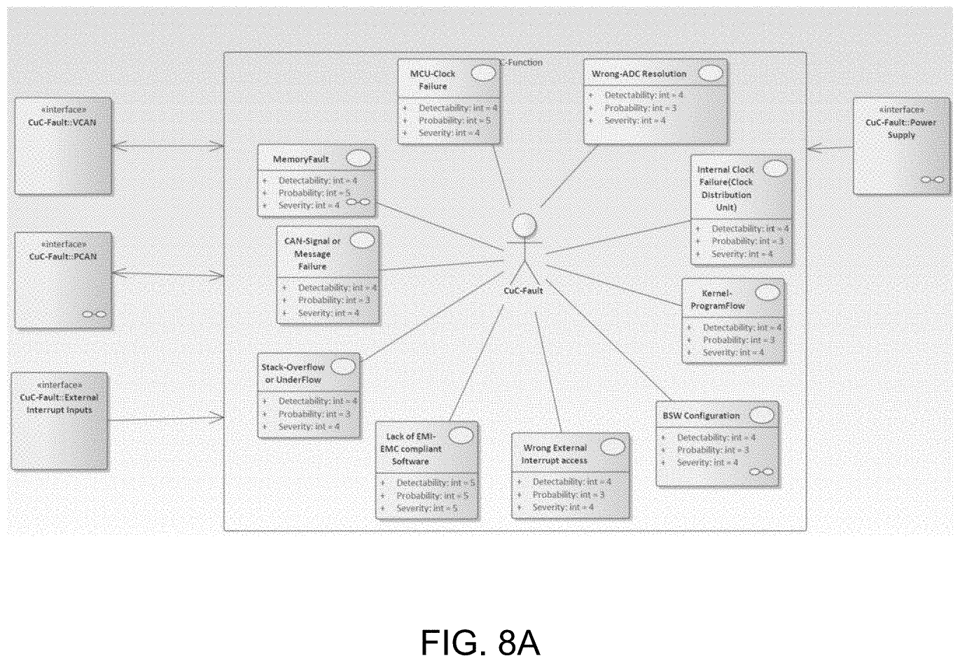

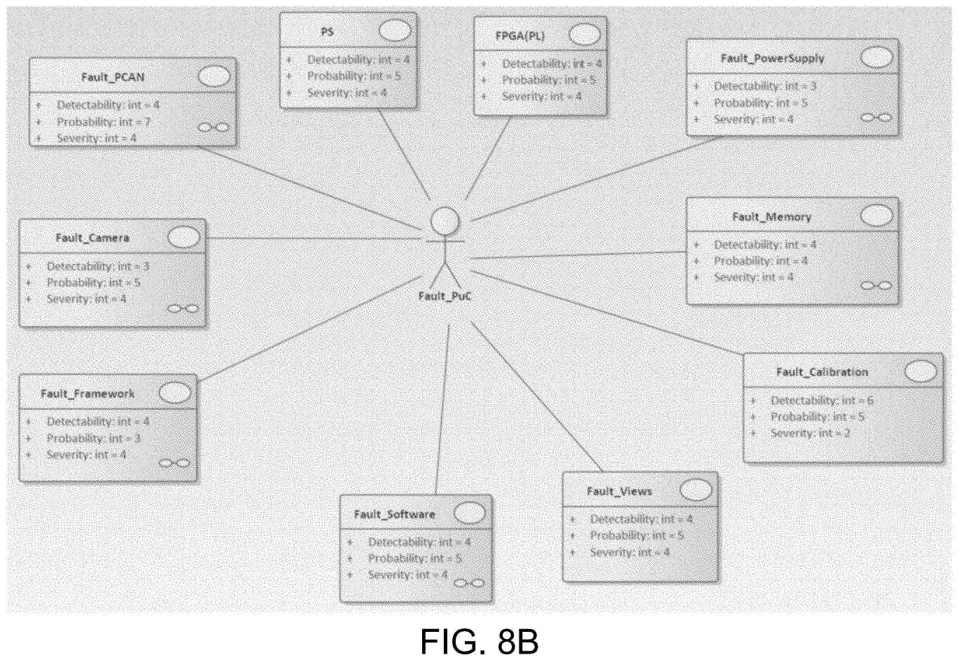

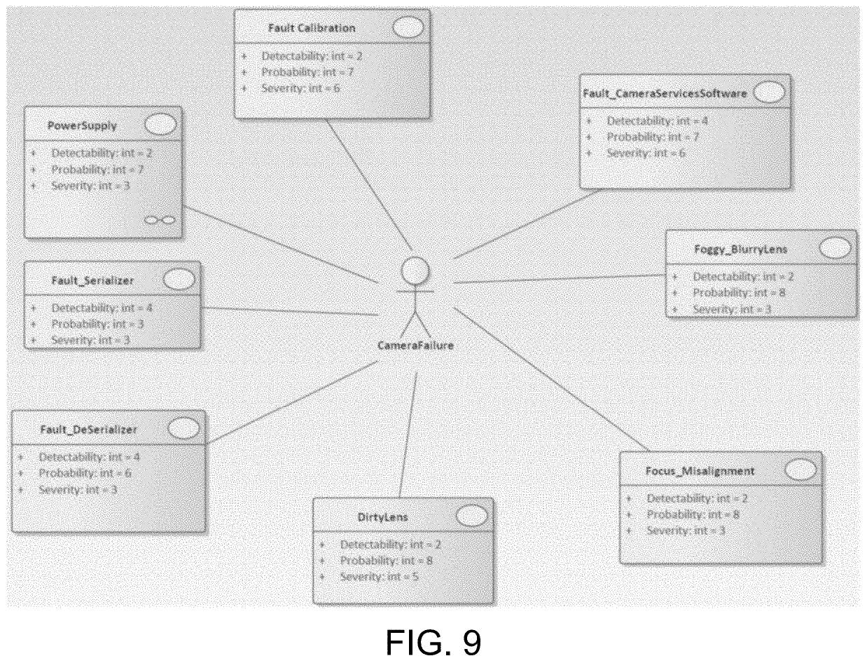

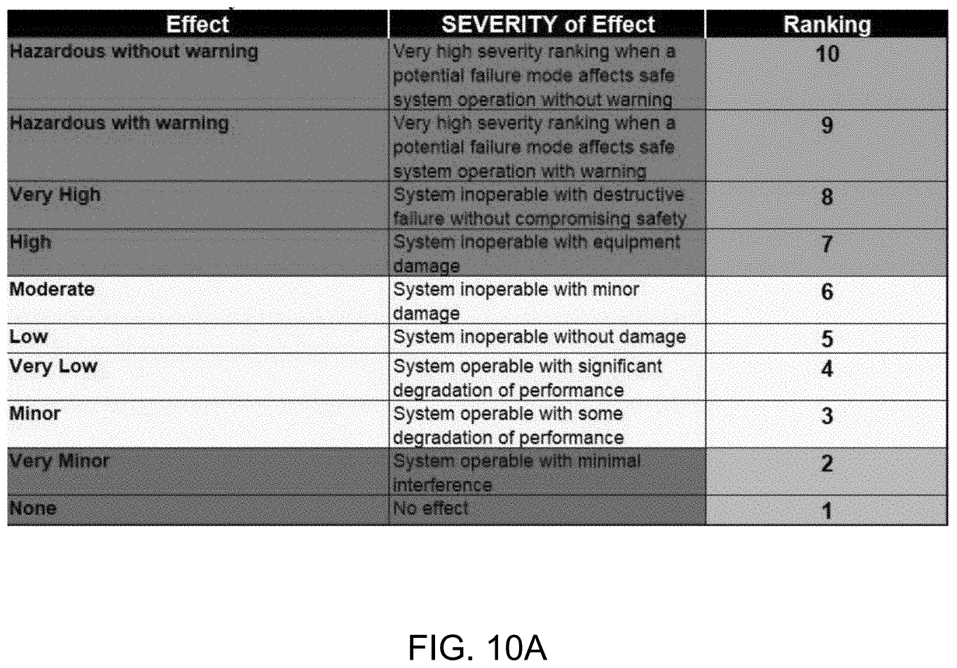

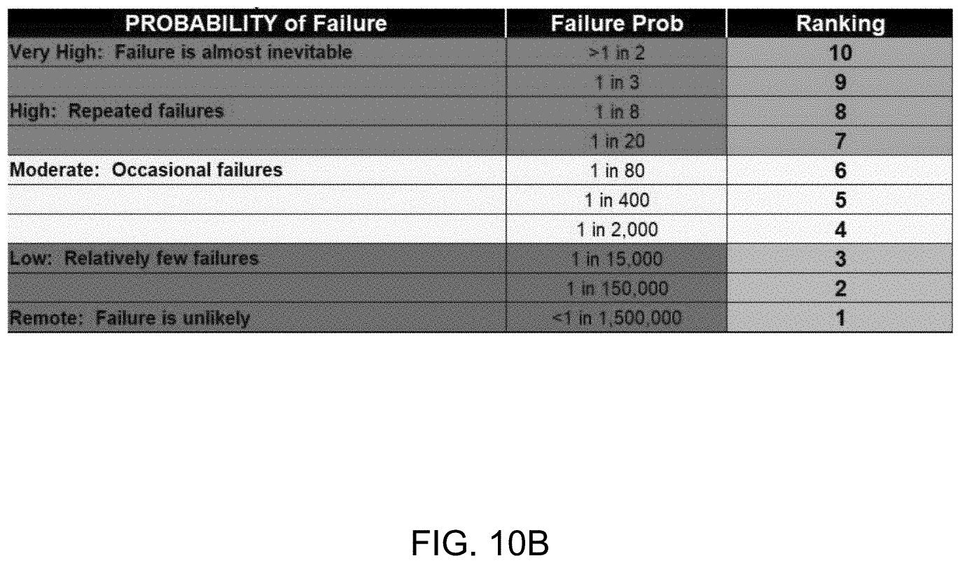

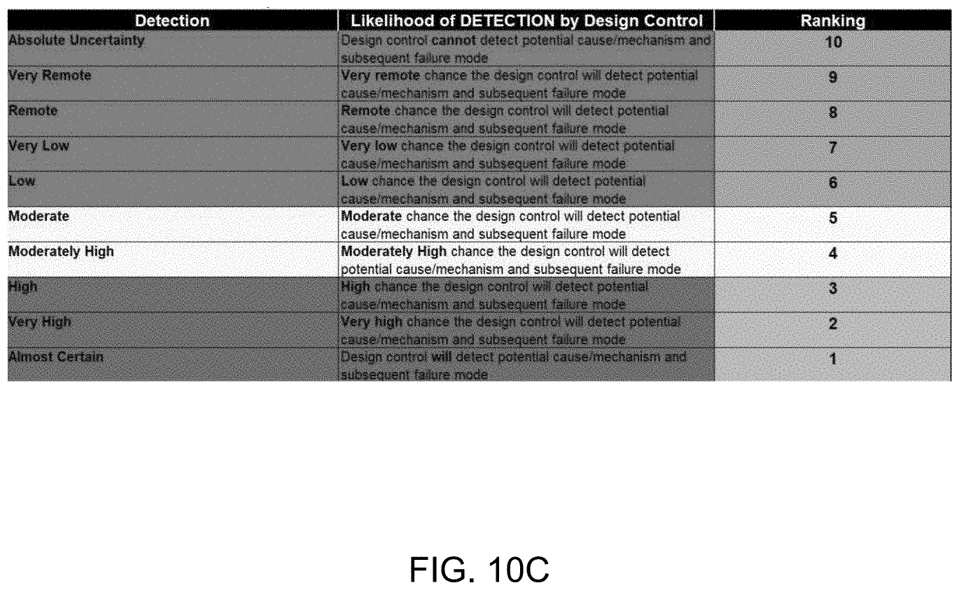

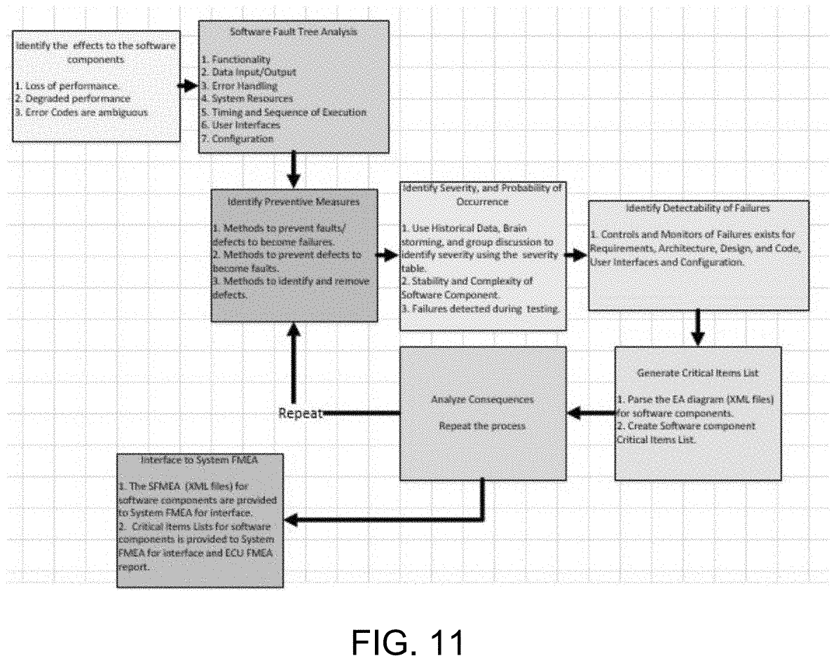

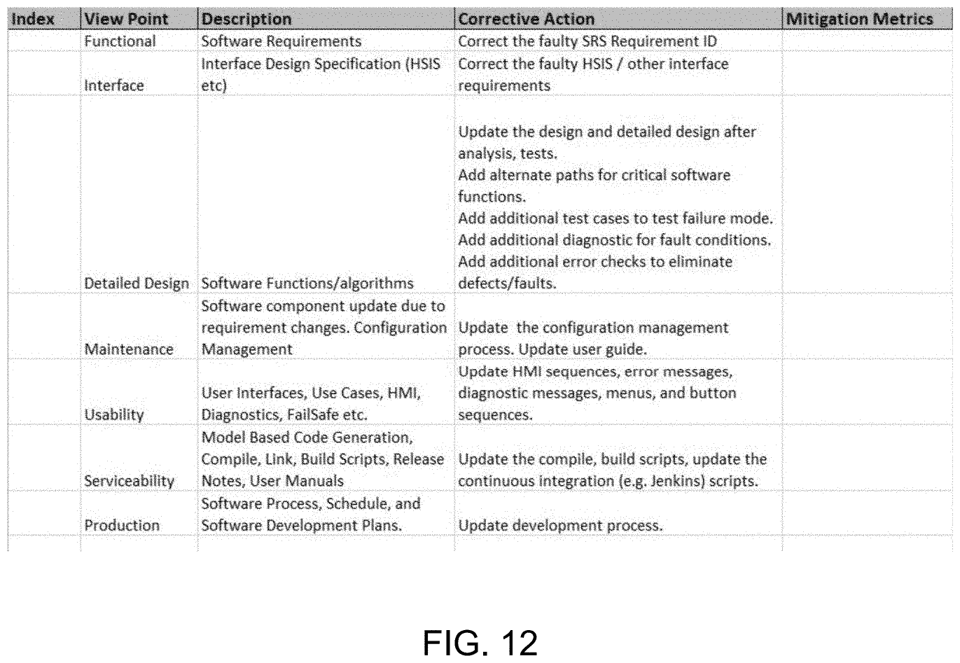

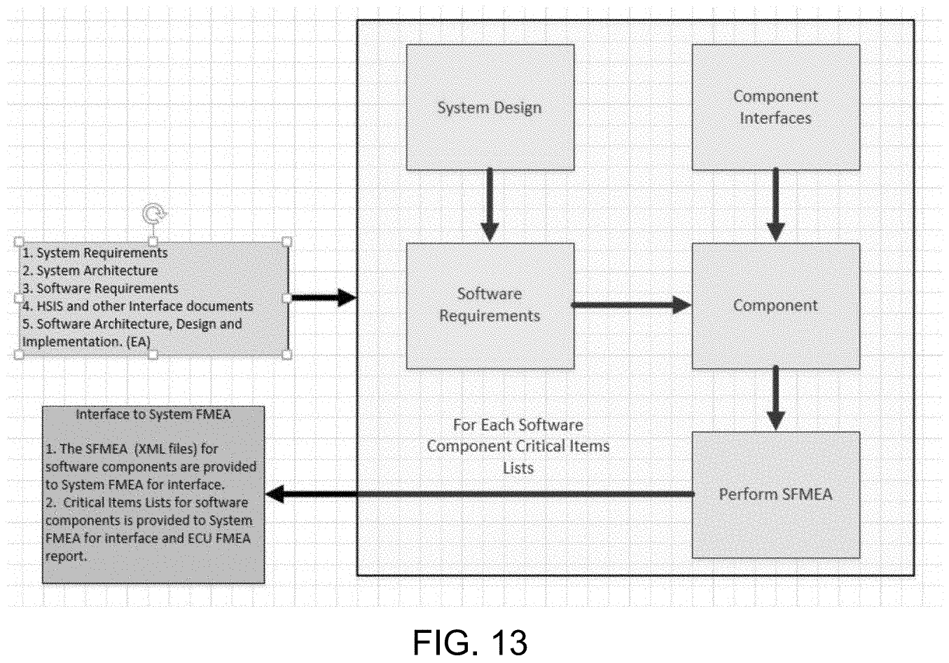

FIGS. 7A-8B provide exemplary high level architecture designs for the SFMEA. FIG. 9 illustrates an example component level view for the SFMEA. Additionally, FIGS. 10A-10C provide tables defining SFMEA severity (FIG. 10A), SFMEA probability of occurrence (FIG. 10B), and SFMEA detectability (FIG. 10C). FIG. 11 illustrates a block diagram describing a method to compute the severity, the probability of occurrence, and the detectability described by FIGS. 10A-10C. FIG. 12 includes a table for describing architecture decisions based on the SFMEA analysis. FIG. 13 includes an exemplary block diagram for the SFMEA interface to a system fault modes and effects analysis.

Thus, implementations herein describe a method for automated generation of SFMEA from Enterprise Architect using SysML models. These models contain block definition diagrams, internal block diagrams, state transition machines, and activity diagrams. The SysML models are created in an EA tool and analysis is performed by parsing the EA software components to produce the various critical items list. Enterprise Architect defines the architecture, design, detailed design, and implementation of the software. This implementation allows complete traceability of software requirements, architecture, design, and implementation.

This reduces the need to duplicate the architectural information and requirement traceability information across multiple tools. Implementations herein describe a method for automated generation of SFMEA from EA using SysML models containing block definition diagrams, internal block diagrams, state transition machines, and activity diagrams. The SysML models may be created in the EA tool, and analysis may be performed by parsing the EA software components to produce the various critical item lists. Some advantages of these implementations include that a single architectural tool is used and that only a single location for architecture, design, implementation, and SFMEA is required. Additionally, the software requirements are traceable to the SFMEA components.

The camera or sensor may comprise any suitable camera or sensor. Optionally, the camera may comprise a “smart camera” that includes the imaging sensor array and associated circuitry and image processing circuitry and electrical connectors and the like as part of a camera module, such as by utilizing aspects of the vision systems described in U.S. Pat. Nos. 10,099,614 and/or 10,071,687, which are hereby incorporated herein by reference in their entireties.

The system includes an image processor operable to process image data captured by the camera or cameras, such as for detecting objects or other vehicles or pedestrians or the like in the field of view of one or more of the cameras. For example, the image processor may comprise an image processing chip selected from the EYEQ family of image processing chips available from Mobileye Vision Technologies Ltd. of Jerusalem, Israel, and may include object detection software (such as the types described in U.S. Pat. Nos. 7,855,755; 7,720,580 and/or 7,038,577, which are hereby incorporated herein by reference in their entireties), and may analyze image data to detect vehicles and/or other objects. Responsive to such image processing, and when an object or other vehicle is detected, the system may generate an alert to the driver of the vehicle and/or may generate an overlay at the displayed image to highlight or enhance display of the detected object or vehicle, in order to enhance the driver's awareness of the detected object or vehicle or hazardous condition during a driving maneuver of the equipped vehicle.

The vehicle may include any type of sensor or sensors, such as imaging sensors or radar sensors or lidar sensors or ultrasonic sensors or the like. The imaging sensor or camera may capture image data for image processing and may comprise any suitable camera or sensing device, such as, for example, a two dimensional array of a plurality of photosensor elements arranged in at least 640 columns and 480 rows (at least a 640×480 imaging array, such as a megapixel imaging array or the like), with a respective lens focusing images onto respective portions of the array. The photosensor array may comprise a plurality of photosensor elements arranged in a photosensor array having rows and columns. Preferably, the imaging array has at least 300,000 photosensor elements or pixels, more preferably at least 500,000 photosensor elements or pixels and more preferably at least 1 million photosensor elements or pixels. The imaging array may capture color image data, such as via spectral filtering at the array, such as via an RGB (red, green and blue) filter or via a red/red complement filter or such as via an RCC (red, clear, clear) filter or the like. The logic and control circuit of the imaging sensor may function in any known manner, and the image processing and algorithmic processing may comprise any suitable means for processing the images and/or image data.

For example, the vision system and/or processing and/or camera and/or circuitry may utilize aspects described in U.S. Pat. Nos. 9,233,641; 9,146,898; 9,174,574; 9,090,234; 9,077,098; 8,818,042; 8,886,401; 9,077,962; 9,068,390; 9,140,789; 9,092,986; 9,205,776; 8,917,169; 8,694,224; 7,005,974; 5,760,962; 5,877,897; 5,796,094; 5,949,331; 6,222,447; 6,302,545; 6,396,397; 6,498,620; 6,523,964; 6,611,202; 6,201,642; 6,690,268; 6,717,610; 6,757,109; 6,802,617; 6,806,452; 6,822,563; 6,891,563; 6,946,978; 7,859,565; 5,550,677; 5,670,935; 6,636,258; 7,145,519; 7,161,616; 7,230,640; 7,248,283; 7,295,229; 7,301,466; 7,592,928; 7,881,496; 7,720,580; 7,038,577; 6,882,287; 5,929,786 and/or 5,786,772, and/or U.S. Publication Nos. US-2014-0340510; US-2014-0313339; US-2014-0347486; US-2014-0320658; US-2014-0336876; US-2014-0307095; US-2014-0327774; US-2014-0327772; US-2014-0320636; US-2014-0293057; US-2014-0309884; US-2014-0226012; US-2014-0293042; US-2014-0218535; US-2014-0218535; US-2014-0247354; US-2014-0247355; US-2014-0247352; US-2014-0232869; US-2014-0211009; US-2014-0160276; US-2014-0168437; US-2014-0168415; US-2014-0160291; US-2014-0152825; US-2014-0139676; US-2014-0138140; US-2014-0104426; US-2014-0098229; US-2014-0085472; US-2014-0067206; US-2014-0049646; US-2014-0052340; US-2014-0025240; US-2014-0028852; US-2014-005907; US-2013-0314503; US-2013-0298866; US-2013-0222593; US-2013-0300869; US-2013-0278769; US-2013-0258077; US-2013-0258077; US-2013-0242099; US-2013-0215271; US-2013-0141578 and/or US-2013-0002873, which are all hereby incorporated herein by reference in their entireties. The system may communicate with other communication systems via any suitable means, such as by utilizing aspects of the systems described in U.S. Pat. Nos. 10,071,687; 9,900,490; 9,126,525 and/or 9,036,026, which are hereby incorporated herein by reference in their entireties.

Changes and modifications in the specifically described embodiments can be carried out without departing from the principles of the invention, which is intended to be limited only by the scope of the appended claims, as interpreted according to the principles of patent law including the doctrine of equivalents.

1. A method for generating fault modes and effects analysis for a vehicular advanced driver-assistance system, the method comprising:
providing a vehicle equipped with an advanced driver-assistance system;
determining a plurality of system components of the advanced driver-assistance system;
determining fault propagation paths between system components of the plurality of system components;
determining internal component fault propagations of system components of the plurality of system components;
determining inter-component failure propagations along each of the determined fault propagation paths;
determining, based on the determined inter-component failure propagations, (i) a severity of failure for each system component, (ii) a probability of failure occurrence for each system component, and (iii) a detectability of failure for each system component; and
generating a critical item list report based at least in part on (i) the determined severity of failure, (ii) the determined probability of failure occurrence, and (iii) the determined detectability of failure.

2. The method of claim 1, wherein each system component of the plurality of system components is determined at least in part using SysML modeling.

3. The method of claim 1, wherein determining the fault propagation paths comprises creating a SysML internal block.

4. The method of claim 1, wherein determining the internal component fault propagations is based on block definition diagrams and transformations using SysML modeling.

5. The method of claim 1, wherein determining the inter-component failure propagations is based on SysML association blocks and failure transformations using internal blocks.

6. The method of claim 1, further comprising generating SysML diagrams using Enterprise Architect.

7. The method of claim 6, further comprising parsing an Enterprise Architect model to tabulate failure data.

8. The method of claim 1, wherein the advanced driver-assistance system comprises a camera disposed at the vehicle.

9. The method of claim 1, wherein the advanced driver-assistance system comprises an electronic control unit (ECU) disposed at the vehicle.

10. A method for generating fault modes and effects analysis for a vehicular advanced driver-assistance system, the method comprising:
providing a vehicle equipped with an advanced driver-assistance system;
determining a plurality of system components of the advanced driver-assistance system using SysML modeling;
determining fault propagation paths between system components of the plurality of system components, wherein determining the fault propagation paths comprises creating a SysML internal block;
determining internal component fault propagations of system components of the plurality of system components;
determining inter-component failure propagations along each of the determined fault propagation paths;
determining, based on the determined inter-component failure propagations, (i) a severity of failure for each system component, (ii) a probability of failure occurrence for each system component, and (iii) a detectability of failure for each system component; and
generating a critical item list report based at least in part on (i) the determined severity of failure, (ii) the determined probability of failure occurrence, and (iii) the determined detectability of failure.

11. The method of claim 10, wherein the advanced driver-assistance system comprises an electronic control unit (ECU) disposed at the vehicle.

12. The method of claim 10, wherein determining the internal component fault propagations is based on block definition diagrams and transformations using SysML modeling.

13. The method of claim 10, wherein determining the inter-component failure propagations is based on SysML association blocks and failure transformations using internal blocks.

14. The method of claim 10, further comprising generating SysML diagrams using Enterprise Architect.

15. The method of claim 14, further comprising parsing an Enterprise Architect model to tabulate failure data.

16. The method of claim 10, wherein the advanced driver-assistance system comprises a camera disposed at the vehicle.

17. A method for generating fault modes and effects analysis for a vehicular advanced driver-assistance system, the method comprising:
providing a vehicle equipped with an advanced driver-assistance system;
determining a plurality of system components of the advanced driver-assistance system;
generating SysML diagrams using Enterprise Architect;
determining, using the SysML diagrams, fault propagation paths between system components of the plurality of system components;
determining internal component fault propagations of system components of the plurality of system components based on block definition diagrams and transformations using SysML modeling;
determining inter-component failure propagations along each of the determined fault propagation paths;
determining, based on the determined inter-component failure propagations, (i) a severity of failure for each system component, (ii) a probability of failure occurrence for each system component, and (iii) a detectability of failure for each system component; and
generating a critical item list report based at least in part on (i) the determined severity of failure, (ii) the determined probability of failure occurrence, and (iii) the determined detectability of failure.

18. The method of claim 17, wherein each system component of the plurality of system components is determined at least in part using SysML modeling.

19. The method of claim 17, wherein determining the fault propagation paths comprises creating a SysML internal block.

20. The method of claim 17, further comprising parsing an Enterprise Architect model to tabulate failure data.
